(19) United States
(12) Patent Application Publication
(10) Pub. No.: US 2007/0005906 A1
(43) Pub. Date: Jan. 4, 2007

(54) Information processing apparatus and cache memory control method

(75) Inventor: Hisaya Miyamoto, Yokohama-shi (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(73) Assignee: KABUSHIKI KAISHA TOSHIBA, Minato-ku (JP)

(21) Appl. No.: 11/454,008

(22) Filed: Jun. 16, 2006

(30) Foreign Application Priority Data
Jun. 29, 2005 (JP) 2005-189948

(51) Int. Cl. G06F 12/00; G06F 12/08

(52) U.S. Cl. 711/143; 711/3

(57) ABSTRACT

There is provided with an information processing apparatus, including: a CPU; a register that stores a task ID or a process ID that identifying a task or a process; and a cache memory that records data specified by the CPU on a cache line corresponding to a memory address specified by the CPU, and writes a task ID or a process ID stored in the register in one part of a tag that manages the cache line as an owner ID; wherein the CPU executes a cache control instruction instructing to write back only cache lines having an owner ID that is the same as a task ID or a process ID in the register.

### CROSS- REFERENCE TO RELATED APPLICATIONS

This application is based upon and claims the benefit of priority from the prior Japanese Patent Applications No. 2005-189948 filed on Jun. 29, 2005, the entire contents of which are incorporated herein by reference.

### BACKGROUND OF THE INVENTION

1 Field of the Invention

The present invention relates to an information processing apparatus and a cache control method for a multi-master (or multi-CPU) environment.

2. Related Art

In a multi-master (or multi-CPU) system, cache coherency, that is, ensuring coherence between a cache (cache memory) and a memory (memory device) has conventionally been an important matter of concern and interest. As a result, many cache snoop mechanisms have been proposed and have contributed to realization of multi-CPU environments.

As some examples, there are the mechanisms for maintaining cache coherence between multiple CPUs as proposed in Japanese Patent Laid-Open No. 2002-163149 and Japanese Patent Laid-Open No. 11-212868.

However, as problems with the arrangement as proposed in Japanese Patent Laid-Open No. 2002-163149, there an increase in the circuit scale as well as overheads for managing tag information of cache memory in the overall system. Further, the snoop mechanism as proposed in Japanese Patent Laid-Open No. 11-212868 results in a situation in which traffic on the bus increases.

Cache categorization as described in Japanese Patent Laid-Open No. 2000-276403 has been proposed as a technique for improving the cache hit rate in a specific CPU. However, in current systems in which the size of programs is increasing, this kind of technique may not necessarily improve the performance of the overall system.

With respect to the above described cache snoop, it may be assumed that the cache snoop will not make a sufficient contribution in the case of the following [Condition 1].

[Condition 1] A master (external master) other than a CPU refers to one part (certain region) of the main memory to read out data or a command string that describes processing. At this time, the physical address that is referred to by the external master in question is not an address that actually exists in a memory device, but is a physical address for which one part of the main memory was mapped by an appropriate system controller. In this case, there is no way for the physical address referred to by the external master to match the physical address of the cache tag, and thus the cache snoop function will not contribute to the process.

Further, even if a case is supposed in which the external master and a CPU refer to same physical addresses on the main memory, when the data amount is large it may be said that in terms of system performance it is preferable to previously write back the data cache, without using the cache snoop function. This will be understood if we consider the process involved. In greater details, when the external master performs a main memory reference, the following procedures are carried out:
1) a snoop signal and a physical address are notified to the CPU from the external master;
2) a cache line corresponding the physical address is retrieved and write-back processing is performed; and
3) after processing associated with sync (synchronizing shared memory), the main memory reference of the external master is performed by limiting the reference to a specific block.

In this case, the greater the data amount, the more frequently the exchange of bus rights will occur in the process 1)→2)→3)→1) . . . →3).

Many CPUs provide cache control means to be utilized by software. Even in a system in which cache snooping is not implemented (or does not function effectively), by performing suitable cache control from software, cache coherency in the multi-master system can be sufficiently guaranteed.

However, in the case of [Condition 2] and [Condition 3] below, cache control by software is not preferable from the viewpoint of overall system performance. That is, it causes a decline in performance.

[Condition 2] In a multitask and multiprocess environment, a case can be supposed in which a certain task (or process) involves storing a large amount of data to be referenced by an external master in the main memory, performing write-back of a data cache, and issuing a read instruction to the external master.

At this time, there is a possibility that the execution right will be switched to another task (or process) while the above described task (or process) is underway, and data that is written or referred to by various tasks (or processes) other than the data written by the above described task (or process) is present in the data cache.

In general, software does not have means for effectively detecting whether or not data written by the software itself is present in a data cache. Accordingly, in the settings for this condition, the above described task (or process) must perform write-back processing for all cache data. Consequently:
1) the time required for write-back processing of a data cache becomes longer than necessary; and
2) data that other tasks (or processes) should refer to is also invalidated unfortunately.

The write-back processing may thus have a considerable effect on the operations of other tasks (or processes) and overall system performance.

Further, the larger the size of the data cache disposed in the CPU, the greater the impact the write-back processing in question has on overall system performance.

[Condition 3] Further, in a process for downloading a program by using a loader program, processing for instruction cache invalidation is also performed in addition to data cache write-back processing. The instruction cache invalidation is also extremely important processing in a closing process for a program (process).

There is no way for a loader program to find out effectively whether or not program data that was downloaded is present in a data cache, and there is likewise no way for a loader program to find out effectively whether or not a line that collides with a downloaded program is present in an instruction cache.

Accordingly, in order to guarantee stable operation of the system, the loader program must sacrifice the overall system performance and execute invalidation processing of overall instruction cache in addition to write-back processing of overall data cache. For this condition also, the larger the size of an instruction cache disposed in a CPU, the greater the impact the invalidation processing in question will have on overall system performance.

### SUMMARY OF THE INVENTION

According to an aspect of the present invention, there is provided with an information processing apparatus, comprising: a CPU; a register that stores a task ID or a process ID identifying a task or a process; and a cache memory that records data specified by the CPU on a cache line corresponding to a memory address specified by the CPU, and writes a task ID or a process ID stored in the register in one part of a tag that manages the cache line as an owner ID; wherein the CPU executes a cache control instruction instructing to write back only cache lines having an owner ID that is the same as a task ID or a process ID in the register.

According to an aspect of the present invention, there is provided with an information processing apparatus, comprising: a plurality of CPUs that are allocated with respectively different CPU-IDs; a register that stores a task ID or a process ID identifying a task or a process; and a cache memory that records data specified by the CPU on a cache line corresponding to a memory address specified by the CPU, and writes a set of a CPU-ID of the CPU and a task ID or a process ID stored in the register in one part of a tag that manages the cache line as an owner ID; wherein the CPU executes a cache control instruction instructing to write back only cache lines having an owner ID that is the same as a set of the CPU-ID of the CPU and a task ID or a process ID stored in the register.

According to an aspect of the present invention, there is provided with a cache memory control method, comprising: issuing by a CPU a cache control instruction instructing write-back of a cache memory; reading out a task ID or a process ID that identifies a task or a process from a register; detecting a cache line that corresponds to a memory address specified by the cache control instruction; checking whether or not a task ID or a process ID stored in one part of a tag of a detected cache line matches a task ID or a process ID in the register; and writing back the detected cache line when the task ID or the process ID of the tag matches the task ID or the process ID in the register.

### BRIEF DESCRIPTION OF THE DRAWINGS

FIG. 1 shows schematically the configuration of a multi-master system relating to one embodiment;

FIG. 2 is a view illustrating information inside a data cache;

FIG. 3 is a flowchart showing the flow of write-back processing in one embodiment;

FIG. 4 is a flowchart showing the flow of processing to invalidate a data cache in one embodiment;

FIG. 5 is a view for explaining write-back processing and invalidation processing;

FIG. 6 is a view showing information that is stored in an instruction cache;

FIG. 7 is a flowchart showing the flow of invalidation processing for an instruction cache;

FIG. 8 shows a system in which a shared memory and a secondary cache that is common to each CPU are provided in a multi-CPU environment;

FIG. 9 is a view showing information within the secondary cache;

FIG. 10 is a flowchart showing the flow of write-back processing for the secondary cache; and

FIG. 11 is a flowchart showing the flow of invalidation processing for the secondary cache.

### DETAILED DESCRIPTION OF THE INVENTION

This embodiment attempts to realize improved performance in a multi-master or multi-CPU environment by effectively performing cache write-back processing or invalidation processing, by adding owner information of each cache line to management information of the cache line. Hereafter, an embodiment of the present invention will be described with reference to the drawings.

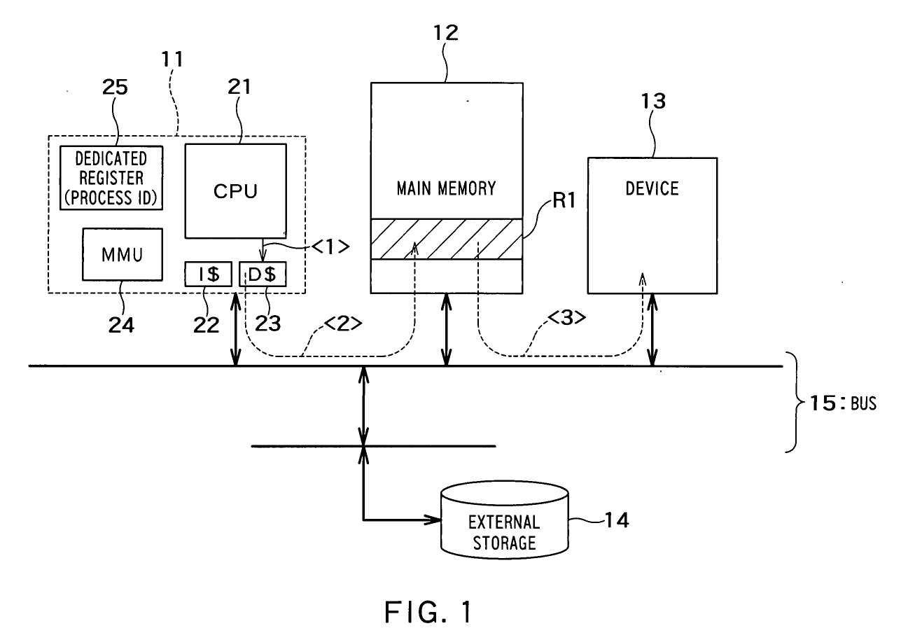

FIG. 1 is a block diagram that schematically shows the configuration of a multi-master system according to this embodiment.

This multi-master system includes an information processing apparatus 11, a main memory 12, a device 13 (for example, a graphic controller), an external storage 14 that stores a plurality of programs or data, and a bus 15 that connects these components. The information processing apparatus 11 has a CPU 21, an instruction cache (I$) 22, a data cache (D$) 23, a memory management unit (MMU) 24, and a dedicated register 25 as one of CPU control registers. The device 13 shares a specific region R1 on the main memory 12 with a program operating on the CPU 21.

In this embodiment, a case is supposed in which the device 13 refers to data that was generated by a program operating on the CPU 21. At this time, as shown in FIG. 1, the data generated by the program is stored in the data cache 23 (<1>), and a forced write-back (<2>) is performed by the program. Thereafter, the device 13 reads out the data (<3>).

Execution of a program is generally managed by use of virtual addresses. The MMU 24 performs association of virtual addresses and physical addresses for readout of programs or for accesses from a program to the memory or another device. When programs to be executed is managed with independent processes, IDs that are managed by the operating system (OS) are individually assigned to the processes, and the correspondence between virtual addresses and physical addresses is managed for each process ID.

The dedicated register 25 stores the process ID that is being executed currently. The MMU 24 can confirm the process ID of the process being executed by referring to the dedicated register 25.

The instruction cache 22 and the data cache 23 are disposed between the CPU 21 and the bus 15. With the exception of specific cases, an indirect memory access is performed via the instruction cache 22 and the data cache 23 in order to read instructions accompanying execution of a program, or in order to perform a data update or memory reference from a program.

A situation will now be considered in which, in this environment, a specific task (or process) generates data for the device 13 on the main memory 12. In order for the device 13 to refer (<3> in FIG. 1) without fail the data on the main memory 12, the data that was generated by the aforementioned specific task (or process) must be written back (<2> in FIG. 1) from the data cache 23.

At this time, if write-back processing for the data cache 23 can be performed for only the data that was written by the aforementioned specific task (or process) among a plurality of tasks (or processes) operating on the CPU 21, it can be considered that a decline in the overall system performance will not occur. The system shown in FIG. 1 has a mechanism whereby write-back of the data cache 23 can be performed for only the data written by a specific task (or process). This is described in detail below.

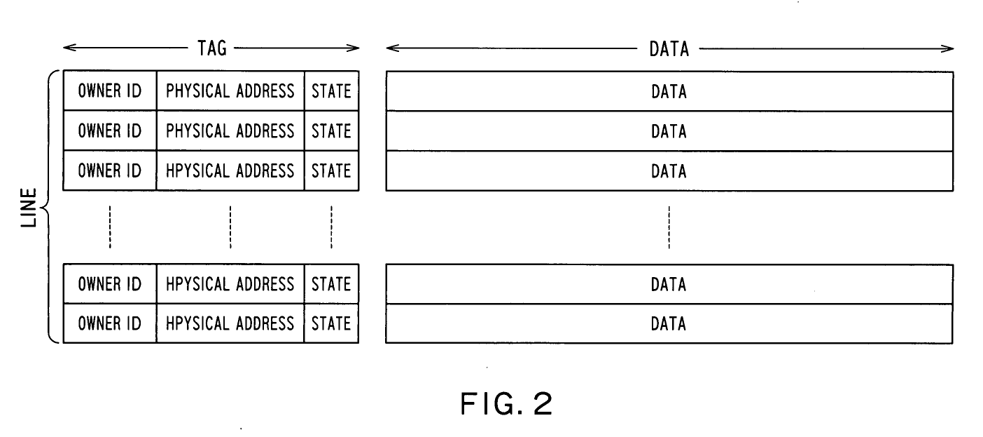

FIG. 2 is a view showing information that is stored in the data cache 23.

The data cache 23 has a plurality of cache lines. In each cache line, a tag that records an owner ID (Owner-ID) as owner information, a physical address (Physical Address), and a state bit is prepared as information for managing the cache line. Data that was read from a memory location corresponding to the physical address recorded in the tag or data to be written at the same physical address is recorded in the data region of the cache line. The owner ID is the ID of the task or the ID of the process (hereunder, referred to commonly as “process ID”) that last made the corresponding cache line dirty (i.e., in a state in which data is written therein). When a data write operation occurred, the process ID in the dedicated register 25 is copied to the tag of the cache line to which the data was written. According to the above described mechanism, since a cache line that was written by a specific task (or process) can be identified, it is possible to write back only a cache line that was written by the specific task (or process). This is described in further detailed below.

In general, a cache is managed by tags that stores respective physical address of the main memory (for an instruction cache, tags are managed by virtual addresses in some cases). In this embodiment, this tag is extended to enable management of the owner of the data in the cache. A process ID can be used as an ID indicating the owner. Process IDs are managed by the OS and it is not necessary for each task or process to know its own process ID. Although a process ID is uniquely issued to each process by the OS in order to manage each process, a mechanism that registers the process ID issued by the OS is also provided in hardware in order to extend and manage a virtual address as a process space using this process ID. For example, in MIPS architecture the process ID of a process that obtained an execution right is managed by a dedicated register (EntryHi register). The owner ID in the above described tag refers to the process ID of the process or task that last made the relevant cache line dirty. The hardware can know the process ID of the process or task that last made the cache line dirty through the existence of the dedicated register 25, and a process ID can be recorded in the tag as the owner. More specifically, when a data write operation occurs, it is sufficient to simply copy the process ID in the dedicated register 25 into the tag of the cache. In this connection, the owner ID that is added to the tag does not have any influence on a cache replacement operation.

A coding example of write-back processing is shown below.

| [program code 1] | |
|---|---|
| la | $2, Base_addr |
| li | $3, Loop_max |
| loop: | |
| cache | D_writeback_OwnerID, way_0($2) |
| cache | D_writeback_OwnerID, way_1($2) |
| cache | D_writeback_OwnerID, way_2($2) |
| cache | D_writeback_OwnerID, way_3($2) |
| addiu | $3, $3, −1 |
| bnel | $3, $0, loop |
| addiu | $2, $2, 0x20 |

Although a write-back request is made for all ways (four ways) and all cache lines, write-back is not performed when the process ID (process ID indicated by the dedicated register 25) performing the write-back processing does not match the owner ID recorded in the tag. The same code functions effectively in the following cases.
Case 1) A case in which the owner itself executes the above described code and writes back a data cache that has the owner ID of the owner.
Case 2) A case in which a privileged process that does not have a process ID, for example, a loader program or the like as one part of the OS function, sets a process ID that should be written back or invalidated from a data cache in the dedicated register 25 and executes the above described code. In this connection, when the loader program was one process which was assigned a process ID and managed by the OS, at the data cache operation stage it is necessary to perform a mode transition to a state in which the process ID that was set by the CPU does not influence execution of the loader program itself, that is, a privileged process for executing the loader program with a kernel space and a kernel mode. Further, before and after a cache operation, an operation is also performed that replaces the process ID (registered in the dedicated register 25) being executed by the process ID of the operation target.

Here, when invalidating a data cache, the parameters of the cache instructions in the above described code are changed in the following manner and executed.

| [program code 2] | |
|---|---|
| la | $2, Base_addr |
| li | $3, Loop_max |
| loop: | |
| cache | D_invalidate_OwnerID, way_0($2) |
| cache | D_invalidate_OwnerID, way_1($2) |
| cache | D_invalidate_OwnerID, way_2($2) |
| cache | D_invalidate_OwnerID, way_3($2) |
| addiu | $3, $3, −1 |
| bnel | $3, $0, loop |
| addiu | $2, $2, 0x20 |

As described above, according to the present embodiment, selective cache control is provided that specifies a process ID of a task (or process) and only performs write-back processing (or invalidation processing) when an owner ID recorded in a tag of the data cache matches the process ID of the task (or process) that is set in the dedicated register 25. More specifically, the CPU executes a cache control instruction instructing to write back or invalidate only cache lines that have an owner ID that is the same as the process ID in the dedicated register 25. In this regard, write-back processing of a cache line is performed when the process ID of the task (or process) matches the owner ID of the data cache and the cache line in question is dirty, and write-back processing is not performed for a cache line having a different owner, even if that cache line is dirty.

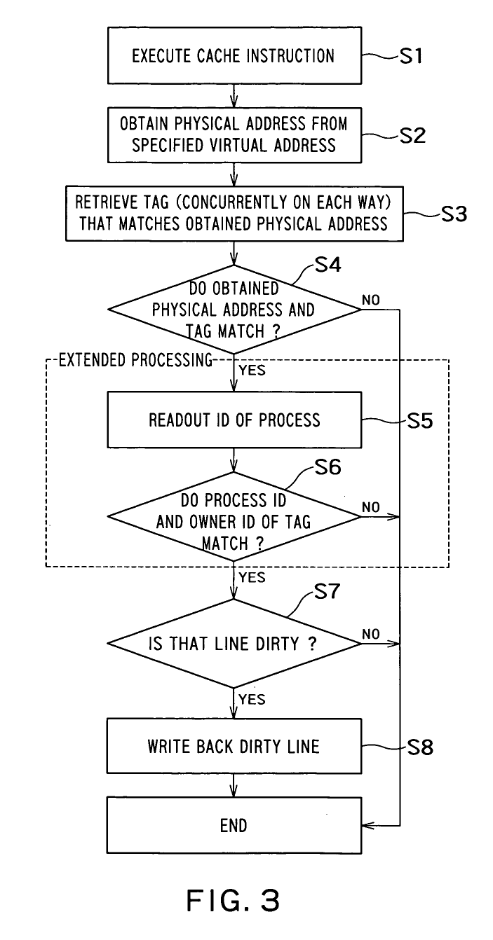

FIG. 3 is a flowchart showing the flow of write-back processing in the present embodiment.

The CPU 21 executes a cache instruction in a certain task (or process) (S1).

The MMU 24 obtains a physical address from a virtual address specified by the CPU 21 based on a process ID that was set in the dedicated register 25 (S2).

The CPU 21 retrieves a tag that matches the obtained physical address. When a plurality of ways exist, it searches each way concurrently (S3).

When there is no tag that matches the obtained physical address (NO at S4), the CPU 21 terminates the processing. In contrast, when a tag exists that matches the obtained physical address (YES at S4), the CPU 21 reads out the process ID from the dedicated register 25 (S5).

The CPU 21 determines whether or not the process ID and the owner ID of the tag match (S6).

When the process ID and the owner ID do not match (NO at S6), the CPU 21 terminates the processing. In contrast, when the process ID and the owner ID match (YES at S6), the CPU 21 determines whether or not the line in question is dirty based on the state bit in the tag (S7).

When the line in question is dirty (YES at S7), the CPU 21 performs write-back processing for that line (S8), and when the line is not dirty (NO at S7), the CPU 21 terminates the processing. In FIG. 3, the processing at S5 and S6 is a part that was newly added with respect to the conventional write-back processing.

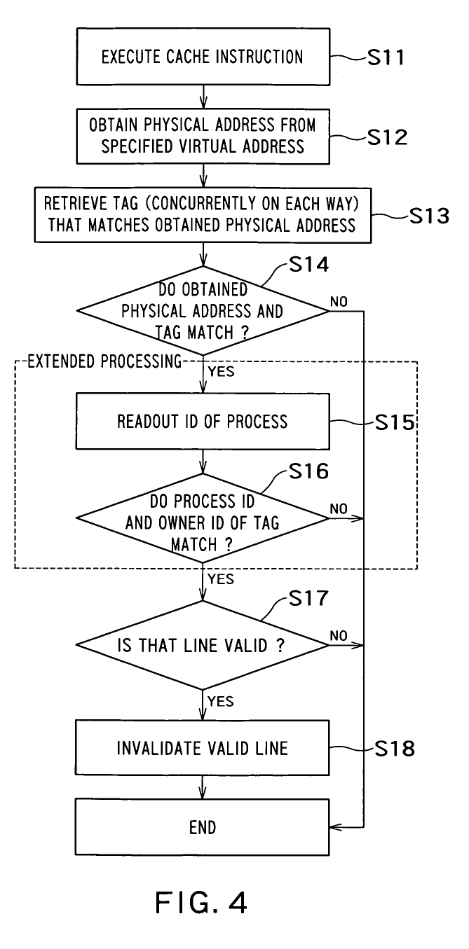

FIG. 4 is a flowchart showing the flow of invalidation processing for a data cache in the present embodiment.

S11 to S16 are the same as S1 to S6 in FIG. 3. At S16, when the process ID and the owner ID of the tag matched (YES at S16), the CPU 21 next determines whether or not the cache line is valid based on the state bit in the tag of the cache line in question (S17). When the cache line is valid (YES at S17), the CPU 21 invalidates the cache line (S18). When the cache line is not valid (NO at S17), the CPU 21 terminates the processing. The processing of S15 and S16 in FIG. 4 is a part that was newly added for the present embodiment with respect to the conventional invalidation processing for a data cache.

Hereunder, write-back processing and invalidation processing for a data cache will be described further taking as an example a case in which program loading processing is performed by a loader program.

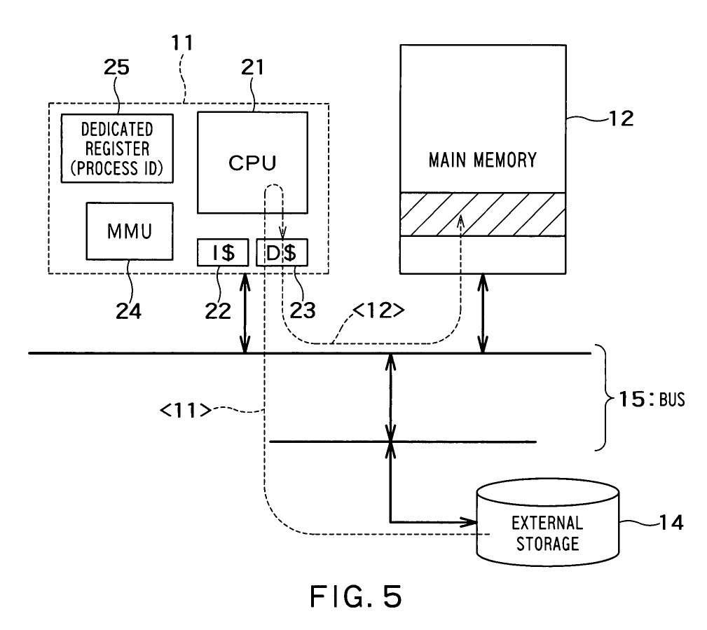

FIG. 5 is a view for explaining write-back processing and invalidation processing to be carried out after program loading processing is performed by a loader program. The system shown in FIG. 5 is the same as that shown in FIG. 1 except that the device 13 is absent. In FIG. 5, parts that are the same as those in FIG. 1 are denoted by the same numbers, and a description of each component is omitted herein.

In this example, a program to be loaded is data that was recorded on the external storage 14 (for example a flash ROM), and that data is loaded to the main memory 12 by a loader program. However, the instruction cache 22 and the data cache 23 are disposed between the CPU 21 and the main memory 12, and thus the data loaded from the external storage 14 is first stored in the data cache 23 (<11>). Before executing the program that was loaded to the main memory 12, it is necessary to surely write back the data corresponding to the loaded program from the data cache 23 used by the loader program to the main memory 12 (<12>).

A plurality of programs other than the loader program are also operating on the CPU 21. Therefore, performing selective write-back processing using a process ID assigned to the loader program by the OS makes it possible to prevent a decline in the performance of the other programs.

Likewise, invalidation processing is performed to invalidate a cache line when the process ID of a target task (or process) that was recorded in the dedicated register 25 matches the owner ID of the cache line in question and the cache line is valid (including clean exclusive and dirty). Invalidation is not performed for a cache line having a different owner ID, even if that cache line is valid.

Although the foregoing description mainly described write-back processing and invalidation processing for a data cache, one embodiment of this invention is also effective when applied to invalidation processing for an instruction cache.

In general, in invalidation processing for an instruction cache, similarly to invalidation processing for a data cache, there is no effective way for software to know which cache line the code of a target process is stored in. Accordingly, to safely operate a system, it is normal to carry out invalidation of overall instruction cache in order to invalidate one process.

Therefore, in this embodiment the tag in the instruction cache is extended, and an owner ID is included in the tag, similarly to the case of the data cache.

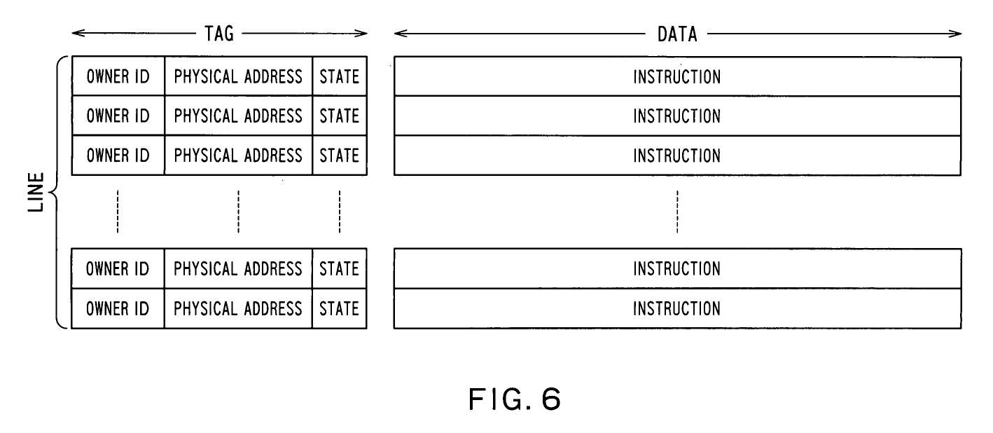

FIG. 6 is a view showing information that is stored in the instruction cache 22.

The instruction cache 22 has a plurality of cache lines. Each instruction cache line has an owner ID (Owner-ID), a physical address (Physical Address), a state bit, and an instruction string. The owner ID, physical address and state bit are managed by a tag. The owner ID is the process ID of the task or process that executed the instruction in the cache line in question. When there is an operation to read in an instruction, the process ID in the dedicated register 25 is copied to the tag of the corresponding cache line. Since it is thus possible to identify a cache line that was used in execution at a specific task (or process), it is possible to invalidate only the cache line that was used to in execution at the specific task (or process). Thus, this embodiment is also effective for invalidation processing of an instruction cache that stores a code of a specific process.

A coding example of invalidation processing for an instruction cache is shown below.

| [program code 3] | |
|---|---|
| la | $2, Base_addr |
| li | $3, Loop_max |
| loop: | |
| cache | I_invalidate_OwnerID, way_0($2) |
| cache | I_invalidate_OwnerID, way_1($2) |
| cache | I_invalidate_OwnerID, way_2($2) |
| cache | I_invalidate_OwnerID, way_3($2) |
| addiu | $3, $3, −1 |
| bnel | $3, $0, loop |
| addiu | $2, $2, 0x20 |

Although an invalidate request is made for all ways and all cache lines, invalidation is not performed unless the process ID (registered in the dedicated register 25) of the subject process for performing the invalidation processing matches the owner ID that is recorded in the tag. Thus, safe and effective invalidation processing for an instruction cache can be realized by a mechanism that selectively invalidates lines of an instruction cache.

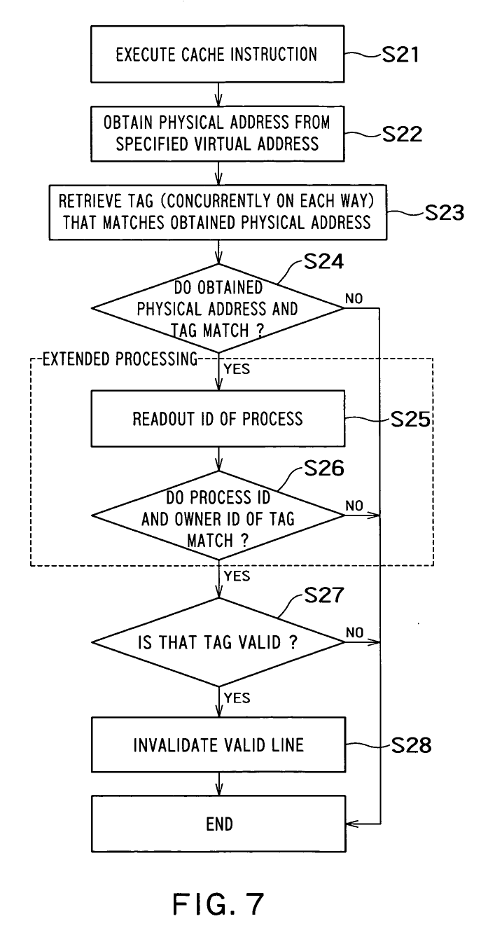

FIG. 7 is a flowchart showing the flow of invalidation processing for an instruction cache.

S21 to S26 are the same as in FIG. 3 and FIG. 4. At S26, when the process ID and the owner ID of the tag match each other (YES at S26), the CPU 21 next determines whether or not the cache line in question is valid based on the state bit in the tag of that cache line (S27). When the cache line is valid (YES at S27), the CPU 21 invalidates that cache line (S28). When the cache line is not valid (NO at S27), the CPU 21 terminates the processing. The processing of S25 and S26 in FIG. 7 is a part that was newly added in the present embodiment with respect to the conventional invalidation processing for an instruction cache.

This kind of selective invalidation processing for an instruction cache effectively functions in the following cases, similarly to selective write-back processing and invalidation processing for a data cache.
Case 3) A case in which the owner itself (task or process) indirectly executes the invalidation processing code for the instruction cache as described above in the termination processing thereof or a transition process to a suspend state, and invalidates instruction cache lines having the owner ID of the owner. In this case, “indirect execution” is assumed to refer to a service performed by the OS.
Case 4) A case in which a privileged process that does not have a process ID, for example, a loader program or the like that is one part of the OS function, sets a process ID that should be invalidated in an instruction cache in the above described dedicated register 25, and executes the invalidation processing code for the instruction cache as described above. In this connection, when the loader program was one process which was assigned a process ID and managed by the OS, at the cache operation stage it is necessary to perform a mode transition to a state in which the process ID that was set by the CPU does not influence execution of the loader program itself, that is, a privileged process for executing the loader program with a kernel space and a kernel mode. Further, before and after a cache operation an operation is also performed that replaces the process ID that is being executed (process ID set in the dedicated register 25) by the process ID of the operation target.

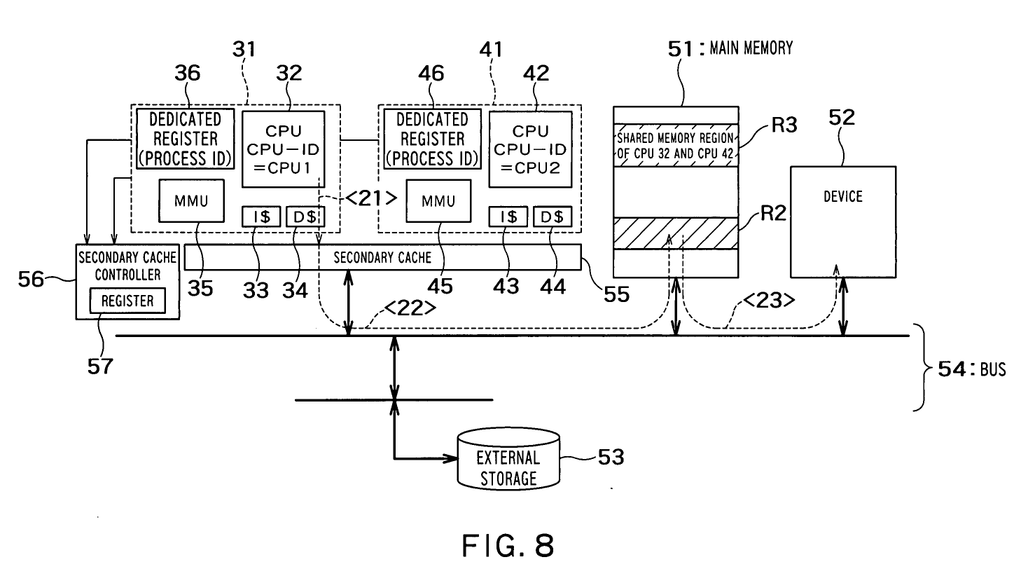

In a multi-CPU environment, a shared memory and a secondary cache that is common for each CPU are provided in some cases. The configuration of a system in this case is shown in FIG. 8.

This system includes two information processing apparatuses 31 and 41, a main memory 51, a device 52 (for example, a graphic controller), an external storage 53 that stores programs or data, and a bus 54 connecting these.

The information processing apparatus 31 has a CPU 32, a primary instruction cache 33, a primary data cache 34, an MMU 35, and a dedicated register 36. The information processing apparatus 41 has a CPU 42, a primary instruction cache 43, a primary data cache 44, an MMU 45, and a dedicated register 46.

The device 52 shares a specific region R2 on the main memory 51 with programs operating on the CPU 32. The CPU 32 and CPU 42 also share a shared region (shared memory) R3 on the main memory 51.

A secondary cache 55 is disposed between the two CPUs 32 and 42 and a bus 54. A dedicated controller (secondary cache controller) 56 is provided for the secondary cache 55. With the exception of specific cases, for reading of instructions accompanying program execution or for memory references from a program, indirect memory accesses are performed via the secondary cache 55 (<21> <22>).

The secondary cache controller 56 has a register (storage) 57 for defining a memory that is shared between the CPUs 32 and 42 on the main memory 51. The register 57 includes an address register that manages the starting physical address of the shared memory and a size register that manages the size of the shared memory. The register 57 corresponds to a first register and a second register. At initialization of the entire system or thereafter, the secondary cache controller 56 registers the starting physical address and size of the shared memory R3 in the register 57. The shared memory that is shared from the CPUs 32 and 42 is defined by the settings of the register 57.

Further, the secondary cache controller 56 manages access to the secondary cache 55 by the CPUs 32 and 42, and extends owner IDs to be registered in tags of the secondary cache 55 with CPU-IDs that are statically assigned to the CPUs 32 and 42 (in this example, CPU1 is assigned as a CPU-ID to the CPU 32, and CPU2 is assigned as a CPU-ID to the CPU 42). That is, in a multi-CPU environment, an individual CPU-ID should be allocated to each CPU, and an owner ID to be written in a tag is extended with the CPU-ID of the each CPU. More specifically, the owner ID in a tag of the secondary cache 55 includes the aforementioned process ID and the CPU-ID that was assigned to the CPU. This is done to prevent a conflict among process IDs that are individually managed on a plurality of CPUs. Accordingly, the same owner ID will not exist for different CPUs in a shared secondary cache. In correspondence to that, a CPU executes a cache control instruction instructing to write back cache lines having an owner ID that is the same as a set the CPU's own CPU-ID and a task ID or a process ID in the dedicated register.

A situation will now be considered in which, in the above described environment, a specific task (or process) executed on the CPU 32 generates data for the device 52 in the specific region R2 on the main memory 51. That is, in this example a case is supposed in which the device 52 refers to data that was generated by a program operating on the CPU 32. At this time, the data that the program has generated is stored in the secondary cache 55 (<21>) and a forced write-back (<22>) is performed by the program. Thereafter, the data is readout (<23>) by the device 52. Meanwhile, as described above, the CPU32 and the CPU42 have a shared memory R3 on the main memory 51.

In order for the device 52 to refer (<23>) the data on the main memory 51 without fail, the data that was generated by the above described specific task (or process) must be written back (<22>) from the secondary cache 55.

Meanwhile, since the programs operating on the CPU 32 and the CPU 42 configure a single system, it is necessary for them to share information with each other. The shared memory R3 on the main memory 51 is used for this information sharing.

It is now assumed that a specific task (or process) executed on the CPU 32 refers to or updates data in the shared memory R3. In this case, a mechanism is also necessary that restricts the feature of the owner ID with respect to a data write operation to the secondary cache 55. The reason is that if data that is shared with other CPUs is also written back when an owner process performs write-back processing, not only is undesirable traffic generated on the bus, but it also influences the efficiency of the secondary cache for the shared memory and the performance of the overall system declines.

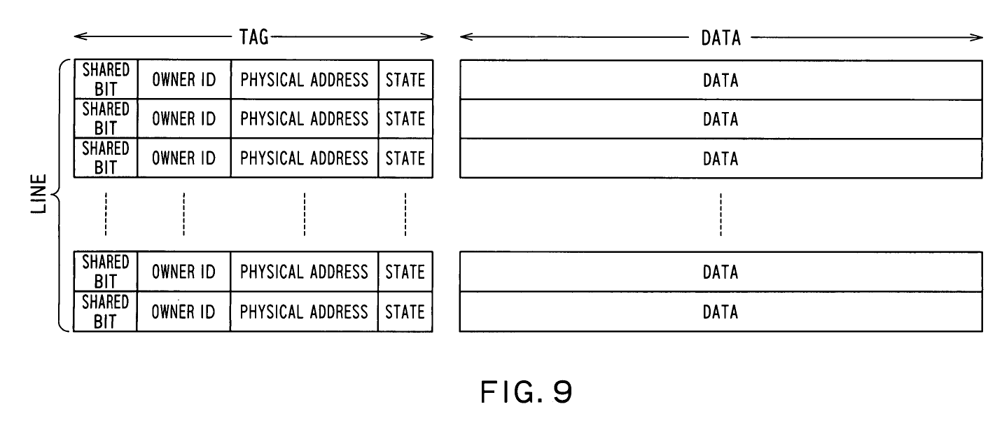

For this purpose, a shared bit (S (shared) bit) is added to the tags. The information in the secondary cache 55 is shown in FIG. 9. When an access is made by the CPU 32 or CPU 42 to the shared memory R3 that was defined in the register 57 in the secondary cache controller 56, the CPU 32 or 42 sends a shared memory access signal to the secondary cache controller 56 via the bus 54. This shared memory access signal is reflected in the tag of the secondary cache 55. More specifically, the shared bit in the tag is set to ON. Further, a set of the process ID and the CPU-ID of the CPU that carried out the access is set in the tag as the owner ID.

According to this mechanism, even though a cache line may be one which is dirty, the features of the process ID and the CPU-ID in the cache line are restricted by the contribution of the shared bit and a write-back to the shared memory R3 is not performed. Cache control is thus provided that does not perform a write-back operation when the shared bit is ON, even in the case of a dirty cache line for which a process ID and a CPU-ID are set in the tag. That is, the CPU executes a cache control instruction instructing to write back only cache lines in which a shared bit is not ON.

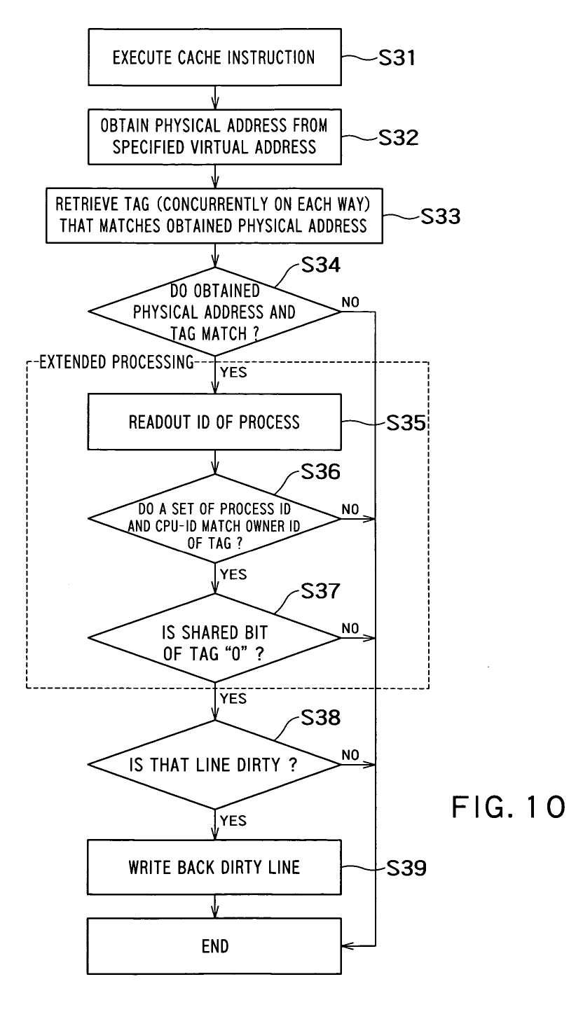

FIG. 10 is a flowchart showing the flow of write-back processing for the secondary cache.

The CPU 32 or CPU 42 executes a cache instruction (S31). The following description is continued on the assumption that the CPU 32 executed the cache instruction.

The MMU 35 obtains a physical address from a virtual address specified by the CPU 32 based on a process ID that was set in the dedicated register 36 (S32).

The CPU 32 retrieves a tag that matches the thus-obtained physical address. When a plurality of ways exist, it searches each way concurrently (S33).

When there is no tag that matches the obtained physical address (NO at S34), the CPU 32 terminates the processing. In contrast, when a tag exists that matches the obtained physical address (YES at S34), the CPU 32 reads out the process ID from the dedicated register 36 (S35).

The CPU 32 determines whether or not a set of the process ID and CPU-ID match the owner ID of the tag (S36).

When the set of the process ID and CPU-ID do not match the owner ID (NO at S36), the CPU 32 terminates the processing. In contrast, when the set of the process ID and CPU-ID match the owner ID (YES at S36), the CPU 32 checks whether the shared bit of the tag is non-shared “0” or shared “1” (S37).

When the shared bit is shared “1” (NO at S37), the CPU 32 terminates the processing. In contrast, when the shared bit is non-shared “0” (YES at S37), the CPU 32 determines whether or not the line in question is dirty from the state bit in the tag (S38).

When the line in question is dirty (YES at S38), the CPU 21 performs write-back processing for that line (S39), and when the line is not dirty (NO at S38), the CPU 32 terminates the processing. In FIG. 10, the processing from S35 to S37 is a part that was newly added with respect to the conventional write-back processing.

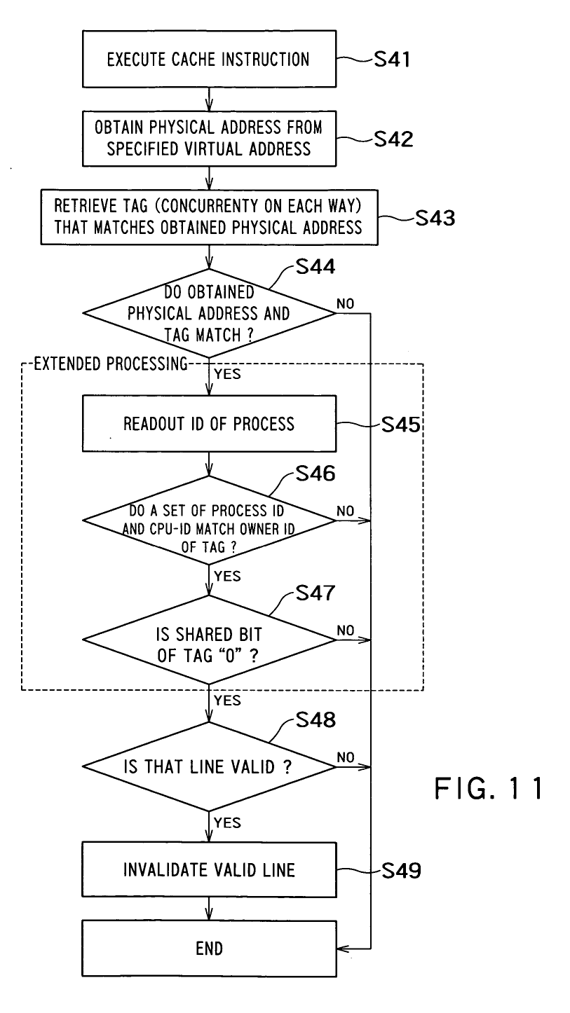

FIG. 11 is a flowchart showing the flow of invalidation processing for the secondary cache.

S41 to S47 are the same as S31 to S37 in FIG. 10. At S47, when the shared bit was non-shared “0” (YES at S47), the CPU 32 determines whether or not the cache line in question is valid based on the state bit in the tag of the cache line (S48). When the cache line is valid (YES at S48), the CPU 32 invalidates the cache line (S49), and when the cache line is not valid (NO at S48) the CPU 32 terminates the processing. The processing from S45 to S47 in FIG. 11 is a part that was newly added for the present embodiment with respect to the conventional invalidation processing.

As described above, according to the embodiment, selective cache invalidation processing and write-back processing can be realized that can improve cache use efficiency in a multi-master system and reduce the bus load.

Further, even in a non multi-CPU environment, the present invention can optimize cache processing when downloading a program and contribute to realizing efficient program operations.

Furthermore, by performing selective cache invalidation processing when deleting or suspending a process, the embodiment enables a further improvement in cache use efficiency.

According to the embodiment, the larger the size of a cache mounted in an information processing apparatus (microprocessor), the greater the effect that is exerted by the embodiment.

What is claimed is:

1. An information processing apparatus, comprising:
a CPU;
a register that stores a task ID or a process ID identifying a task or a process; and
a cache memory that records data specified by the CPU on a cache line corresponding to a memory address specified by the CPU, and writes a task ID or a process ID stored in the register in one part of a tag that manages the cache line as an owner ID;
wherein the CPU executes a cache control instruction instructing to write back only cache lines having an owner ID that is the same as a task ID or a process ID in the register.

2. The information processing apparatus according to claim 1, wherein the cache memory is a data cache.

3. The information processing apparatus according to claim 1, wherein the CPU executes a cache control instruction instructing to invalidate only cache lines having an owner ID that is the same as a task ID or a process ID stored in the register.

4. The information processing apparatus according to claim 3, wherein the cache memory is a data cache.

5. The information processing apparatus according to claim 4, wherein the cache memory is an instruction cache.

6. An information processing apparatus, comprising:
a plurality of CPUs that are allocated with respectively different CPU-IDs;
a register that stores a task ID or a process ID identifying a task or a process; and
a cache memory that records data specified by the CPU on a cache line corresponding to a memory address specified by the CPU, and writes a set of a CPU-ID of the CPU and a task ID or a process ID stored in the register in one part of a tag that manages the cache line as an owner ID;
wherein the CPU executes a cache control instruction instructing to write back only cache lines having an owner ID that is the same as a set of the CPU-ID of the CPU and a task ID or a process ID stored in the register.

7. The information processing apparatus according to claim 6, wherein the CPU executes a cache control instruction instructing to invalidate only cache lines having an owner ID that is the same as a set of the CPU-ID of the CPU and a task ID or a process ID in the register.

8. The information processing apparatus according to claim 6, further comprising:
a storage that stores information that defines a shared region in a main memory, the shared region being shared by the CPUs via a bus; and
a cache controller that sets a shared bit in other part of the tag managing the cache line in a case where a memory address specified by the CPU belongs to the shared region;
wherein the CPU executes a cache control instruction instructing to back write only cache lines for which the shared bit is not set, among the cache lines having the owner ID.

9. The information processing apparatus according to claim 8, wherein the storage includes a first register that stores a starting address of the shared region and a second register that stores a size of the shared region.

10. The information processing apparatus according to claim 6, further comprising:
a storage that stores information that defines a shared region in a main memory, the shared region being shared by the CPUs via a bus; and
a cache controller that sets a shared bit in other part of the tag of the cache line in a case where a memory address specified by the CPU belongs to the shared region;
wherein the CPU executes the cache instruction instructing to invalidate only cache lines for which the shared bit is not set, among the cache lines having the owner ID.

11. The information processing apparatus according to claim 10, wherein the storage includes a first register that stores a starting address of the shared region and a second register that stores a size of the shared region.

12. The information processing apparatus according to claim 6, wherein the cache memory is a secondary cache.

13. The information processing apparatus according to claim 7, wherein the cache memory is a secondary cache.

14. A cache memory control method, comprising:
issuing by a CPU a cache control instruction instructing write-back of a cache memory;
reading out a task ID or a process ID that identifies a task or a process from a register;
detecting a cache line that corresponds to a memory address specified by the cache control instruction;
checking whether or not a task ID or a process ID stored in one part of a tag managing a detected cache line matches a task ID or a process ID in the register; and
writing back the detected cache line when the task ID or the process ID of the tag matches the task ID or the process ID in the register.

15. The cache memory control method according to claim 14, further comprising:
issuing by the CPU a cache control instruction instructing invalidation of the cache memory; and
invalidating the detected cache line when a task ID or a process ID stored in one part of the tag matches a task ID or a process ID in the register.
